(19) United States
(12) Patent Application Publication
(10) Pub. No.: US 2005/0104386 A1
(43) Pub. Date: May 19, 2005

(54) Black belt

(76) Inventor: Bryan Kevin Underwood, Powell, TN (US)

Correspondence Address: Bryan K. Underwood, 7717 Tabeel Terrace, Powell, TN, 37849, US

(21) Appl. No.: 10/715,620

(22) Filed: Nov. 19, 2003

(51) Int. Cl. E05C 19/18

(52) U.S. Cl. 292/262

(57) ABSTRACT

A security device mounted on an entrance door allowing partial opening of the door for viewing while the door remains secure. The device comprising of a U channel wall bracket mounted in the wall substructure with a lag bolt, a U channel door bracket with slots on the inner side, mounted with screws on the opening end of door being equal in elevation with wall bracket from floor. A neoprene/rubber belt with dowel pins affixed equally at each end, one affixed dowel pin in the wall bracket allowing for rotation of the belt across the door and into the U channel door bracket at which point the opposite dowel pin engages the slots on the door bracket creating a energy absorbing device when force is applied to the door i.e. kicking, shoving

### BACKGROUND OF INVENTION

This invention relates to door security devices especially door devices Which allows the door to be partially open while still secure.

One common type commonly found in residents and in hotel/motel Rooms which is a door chain which has a plate attached with screws On the inside of a door, the door plate having a slot with a larger opening At one end while the jam has a jam plate attached with screws, a chain is Attached to the jam plate at one end and a slide bolt on one end which can Be placed in the larger opening of the door plate and slid down the slot to Enable the door to be partially open while remaining secure. Another type Is an elongated “u” shaped bar that is mounted to the door jam/door trim And is rotated across the door to a catch mounted on the door which the Catch can slide within the “u” shaped bar. The principal disadvantage to Both of these prior art type devices is that they are mounted with screws In the door jam/door trim and that they are fully comprised of solid Or composite metals which cannot absorb energy “i.e. a kick or impact To the door” which causes failure through breaking the device or breaking Out the screws and allowing an intruder to enter the area.

This invention is aimed at a more secure lock system, allowing partial Opening of the door, using a stronger mounting to the door and a energy Absorbing device.

### SUMMARY OF INVENTION

The present invention is aimed at a security device which is mounted on a door above the area of a dead bolt lock, similar to that of a chain lock or a flip bar lock With viewing capabilities, the device having a bracket mounted in the door frame substructure and a bracket mounted on the door with each bracket at equal elevation and a neoprene or special formulated rubber belt attached between them, able to be engaged or disengaged at the door bracket end, which provides energy absorbing action “i.e. impact, kick, push to a door, enabling the occupant time to react, escape or notify for assistance.

### BRIEF DESCRIPTION OF DRAWINGS

FIG. 1, is a view of device as mounted on entrance door structure.

FIG. 2, is a exploded view of device, numbered in assembly order

### DESCRIPTION OF THE PREFERRED EMBODIMENT

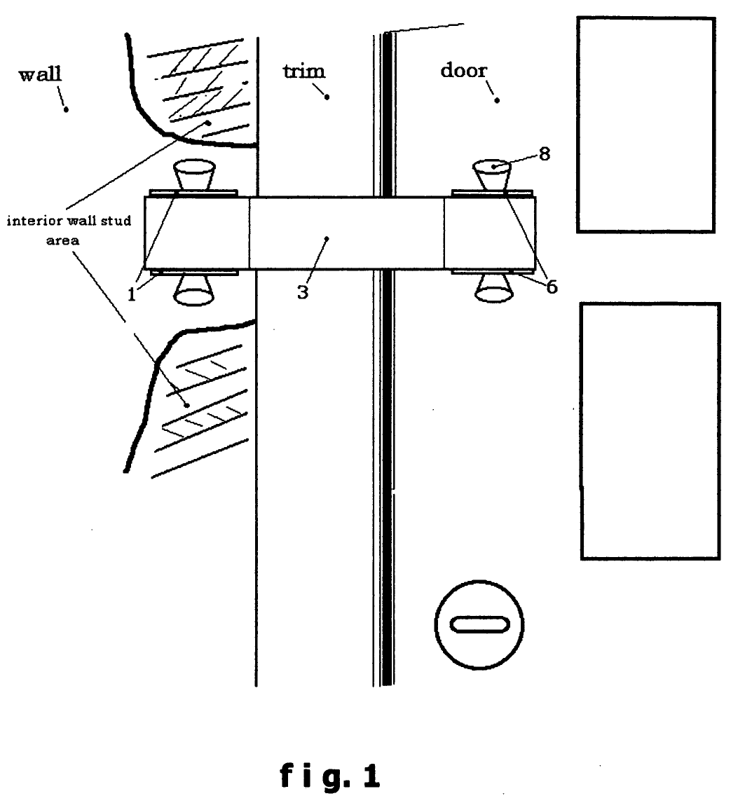

FIG. 1, showing relationship of device as mounted on door structure wall area adjacent to door trim and door on opening side of Door, “noting interior wall structure” “door frame studding”, Whereas the wall bracket of device would be secured.

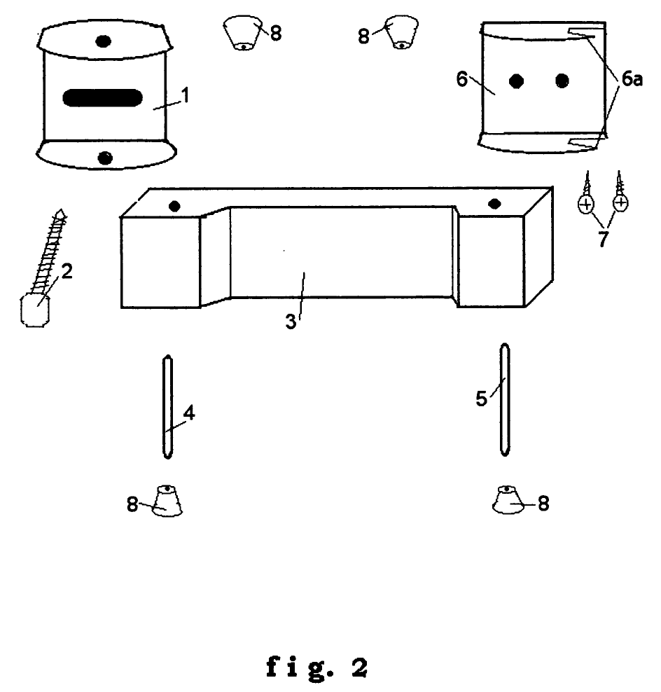

FIG. 2, noting device should be mounted approximately 5 ft. from floor the wall bracket “1” would be located on the wall beside the door trim on the opening side of the door as shown in FIG. 1 using lag bolt “2” lag bolt “2” should be at a minimum length of 2.5″ inches to ensure a deep enough penetration into the door frame structure, “wall stud” for strength and durability, and then belt “3” would be inserted into the channel of the wall bracket, aligning the pre drilled holes in the wall bracket “1” and the pre drilled holes in the belt “3” then inserting retaining pin “4” through the holes, then placing retaining pin “5” in the pre drilled hole of the door end of the belt “3” then door bracket “6” having a slotted side “6a” would be placed on door with slotted side “6a” opposing door opening side, aligning it evenly with wall bracket “1” as so when device is engaged the belt “3” is horizontal as shown in FIG. 1, also ensuring that retaining pin “5” which has been inserted into door end of belt “3” will pass the leading edge of “6a” on the door bracket “6” marking the placement on the door, then pre drilling the marks and insert screws “7” into place, then adding decorative caps “8” onto each end of retaining pins “4” and “5” noting decorative caps functional purpose is to assist in engaging and disengaging device by hand. It should also be noted that the type of door [i.e. wood, metal, etc.] is not material, and present invention can be used on any type door, [i.e. standard, french style, sliding glass, etc

1. A security device for entrance doors comprising of a wall bracket mounted adjacent to the door trim on the opening side of the door and a door bracket mounted on the face of the door on the opening side with a neoprene/rubber belt affixed to the wall bracket rotating to the door bracket engaging door bracket allowing partial viewing by occupant while the door remains secure.

2. A security device as claimed in claim 1. To prevent unaware exiting of youth or toddler of residence
